(19) United States
(12) Patent Application Publication
(10) Pub. No.: US 2015/0095172 A1
(43) Pub. Date: Apr. 2, 2015

(54) METHODS AND SYSTEMS FOR RECURRING FINANCIAL TRANSACTIONS AT POINT OF SALE TERMINAL

(71) Applicant: Fusebill Inc., Kanata (CA)

(72) Inventors: Greg Burwell, Stittsville (CA); Kareem Sultan, Ottawa (CA)

(21) Appl. No.: 14/499,616

(22) Filed: Sep. 29, 2014

Related U.S. Application Data
(60) Provisional application No. 61/883,474, filed on Sep. 27, 2013.

(51) Int. Cl. G06Q 30/04; G06Q 20/14; G06Q 20/20

(52) U.S. Cl. CPC G06Q 30/04; G06Q 40/06; G06Q 20/20; G06Q 20/14
USPC 705/16; 705/34; 705/36 R

(57) ABSTRACT

Large volumes of financial transactions are processed today across a variety of financial platforms including but not limited to debit cards, credit cards, prepaid cards, e-purse, Automatic Teller Machine (ATM) transactions, and Point of Sale (POS) cards. The vast majority of these relate to discrete transactions undertaken either by the user being physically present at a POS purchase or undertaking an online purchase. However, in many instances, particularly with respect to services, it would be beneficial if the user via financial transaction software systems and/or software applications could authorize periodic transactions in respect to the service and/or wares. It would be further beneficial if the periodic or recurring transactions could be established by the user at a POS and that the timescales of these transactions could be established with high flexibility.

### CROSS-REFERENCE TO RELATED APPLICATIONS

This patent application claims the benefit of U.S. Provisional Patent Application 61/883,474 filed on Sep. 27, 2013 entitled “Methods and Systems for Recurring Financial Transactions at Point of Sale Terminal.”

### FIELD OF THE INVENTION

The present invention relates to financial transactions and more particularly to establishing recurring financial transactions at terminals.

### BACKGROUND OF THE INVENTION

A financial transaction is an agreement, communication, or movement carried out between a buyer and a seller to exchange an asset or provide a service in response to or prior to an exchange of payment from the buyer to the seller. It involves a change in the status of the finances of two or more businesses or individuals as a result. The buyer and seller are separate entities or objects, often involving the exchange of items of value, such as information, goods, services, and money.

One particular form of financial transaction is the subscription or contract and its associated subscription (contract) business model wherein a customer pays a subscription price to have access to the product/service. The model historically associated with utilities was pioneered in broader application by magazines and newspapers, but is now used by many businesses, including for example cable TV service providers and cellular service providers, and websites, including for example multimedia content distributors and online newspapers. Even where a product or service is sold or ordered individually, e.g. a cellular telephone, a subscription or contract between the seller and purchaser exists which establishes periodic (e.g. monthly, yearly, or seasonal) payments for continued use or access to the product and/or service.

Industries that use this model include, but are not limited to, mail order clubs, cable television, satellite television providers, pay-TV channels, satellite radio, telephone companies, cell phone companies, Internet providers, software providers, business solutions providers, financial services firms, fitness clubs, and pharmaceuticals, as well as the traditional newspapers, magazines and academic journals. Utilities may also be subscription based with equipment rentals as well as consumption based charging. Subscriptions and contracts may be for fixed period with the requirement that the user renew the subscription/contract at the end of this fixed period or they be open ended requiring the user to terminate them. Historically, such subscriptions were established and the user invoiced monthly wherein the user in paying each month may have visited a bank, mailed a check, mailed money, or visited an outlet of the enterprise to pay. Recently, enterprises and financial institutions have allowed the user once the subscription/contract has been established to elect to have automatic payment plans with withdrawals from a checking account or a pre-authorized charge to a credit card. However, no mechanism exists today for a user to establish or modify at a POS a recurring charge against a financial instrument simplifying the establishment and management of such recurring billing processes for all parties involved. Further, at present any recurring billing process is determined by the billing practices of the service/ware provider, e.g. utilities typically execute month end billing, whereas it would be beneficial to allow flexibility in the recurring billing for the user. Similarly, providing users and enterprises with increased flexibility in establishing recurring billing, such as on daily, hourly, per minute basis, would be beneficial in light of the wide range of services and wares accessible to the user which are currently not billed in such a manner.

Accordingly it would be beneficial to provide a financial transaction software system and/or software application supporting the establishment of recurring billing as part of processing financial transactions across a variety of financial platforms including but not limited to debit cards, credit cards, prepaid cards, e-purse, Automatic Teller Machine (ATM) transactions, and Point of Sale (POS) cards. Further it would be beneficial if the financial transaction software system and/or software application supported discrete and periodic transactions wherein the timescales of transactions may be established with increased flexibility over existing prior art billing systems. For example an electrical utility executes billing monthly and runs their processing on a predetermined day each month for a customer based upon a sequence of the utility rather than other characteristics such as the date the customer registered with the utility or a customer preference to be billed bi-monthly and 2 days after their bi-monthly salary is deposited into their account.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to address limitations in the prior art relating to financial transactions and more particularly to automated periodic processing of financial transactions.

In accordance with an embodiment of the invention there is provided a method comprising automatically establishing at a terminal a recurring billing process.

In accordance with an embodiment of the invention there is provided a method comprising receiving at a terminal data relating to at least one of a product and a service, receiving at the terminal data relating to a financial instrument associated with a user, and establishing in relation to the at least one of a product and a service a recurring billing process.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a telecommunications network supporting communications to and from electronic devices and servers implementing financial transactions according to embodiments of the invention;

FIG. 2 depicts schematically a system architecture for a system implementing financial transactions according to embodiments of the invention;

FIG. 3 depicts schematically a system architecture for a system implementing financial transactions according to embodiments of the invention;

FIG. 4 depicts an exemplary flowchart for establishing a recurring billing linked to a user's financial instrument according to an embodiment of the invention;

FIG. 5 depicts an exemplary flowchart for establishing a recurring billing linked to a user's financial instrument according to an embodiment of the invention; and

FIG. 6 depicts an exemplary flowchart relating to processing subscriptions which represent recurring billing processes.

### DETAILED DESCRIPTION

The present invention is directed to financial transactions and more particularly to establishing recurring financial transactions at terminals.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A “portable electronic device” (PED) as used herein and throughout this disclosure, refers to a wireless device used for communication that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, and an electronic reader. A “fixed electronic device” (FED) as used herein and throughout this disclosure, refers to a device used for communication that is dependent upon a connection to a connection to an electrical mains or other form of distributed energy for power. This includes devices, but is not limited to, such as a desktop computer, television, gaming console, kiosk, and a terminal.

A “network operator/service provider” as used herein may refer to, but is not limited to, a telephone or other company that provides services for mobile phone subscribers including voice, text, and Internet; telephone or other company that provides services for subscribers including but not limited to voice, text, Voice-over-IP, and Internet; a telephone, cable or other company that provides wireless access to local area, metropolitan area, and long-haul networks for data, text, Internet, and other traffic or communication sessions; etc.

A “wares provider” and/or “service provider” as used herein and through this disclosure refers to, but is not limited to, a provider of wares (goods/products) and/or services (direct/indirect) to a user or on behalf of a user. This includes, but is not limited to, retailers, stores, shops, utilities, network operators, service providers, and charities. A “subscription” as used herein and through this disclosure refers to, but is not limited to, a financial transaction. This includes, but is not limited to, annual contracts, fixed term contracts, pay-per-use activities, etc. A purchase may be considered within embodiments of the invention as a subscription with a single occurrence.

A “financial registry” as used herein and through this disclosure refers to, but is not limited to, a database of customer and/or subscriber information relating to finances including, but not limited to, financial instruments such as credit cards, debit cards, and gift cards for example; financial services such as loans, mortgages, and banking for example; and financial accounts such as those relating to checking, savings, mortgage, line of credit, shares, and Government regulated savings. A “user,” as used herein and through this disclosure refers to, but is not limited to, a person or device that utilizes the financial registry, either as a provider of a product, ware, and/or service, controller of the financial registry, a financial provider of a financial product and/or service, or as a client of a product, ware, and/or service provider. A “registered party” as used herein may refer to a person, group, or organization that has registered with a financial registry and may or may not be the intended recipient of monies or intended provider of monies associated with a financial transaction. A “financial provider” as used herein may refer to any provider of financial services, either online and/or in a traditional physical location including, but not limited to, credit, debit, and loan services against which financial charges are made arising from periodic and/or aperiodic transactions relating to a user and/or registered party.

A “software system” as used herein and through this disclosure refers to a computer, server, or other microprocessor based device either alone or in combination with other microprocessor based devices communicating with one another via at least one telecommunications protocol to support one or more software applications providing one or more functions associated with the financial registry including those for users, registered parties, financial providers, and others accessing the financial registry. A “software application” as used herein and through this disclosure refers to a set of programs, procedures, algorithms and associated documentation concerned with the operation of a data processing system according to embodiments of the invention relating to providing one or more functions associated with the financial registry including those for users, registered parties, financial providers, and others accessing the financial registry.

A “terminal” as used herein and through this disclosure refers to a kiosk, machine, electronic device or station either alone or in combination with other devices that supports the execution of a financial transaction by a user. This includes, but is not limited to, cash registers, automatic teller machines (ATMs), point of sale (POS) terminals, kiosks, cloud-based POS, web based retailer portals, telephonic POS, RF based POS, web based virtual stores with virtual checkouts, etc.

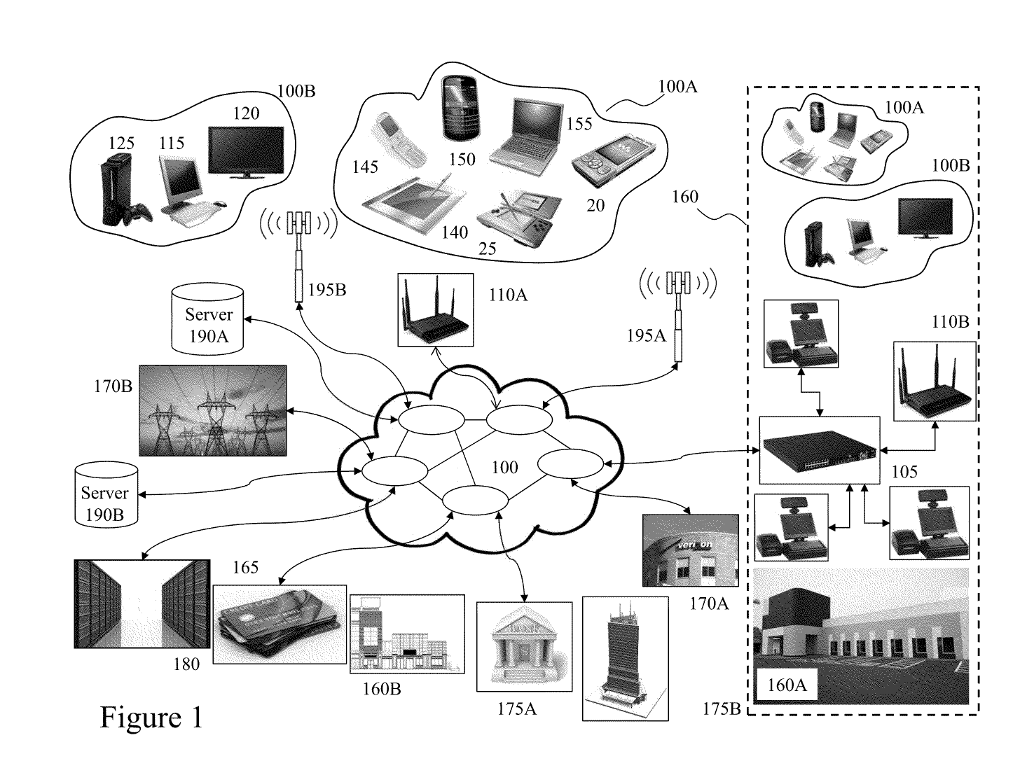

Now referring to FIG. 1 there is depicted a telecommunications network 100 supporting communications to and from electronic devices providing information relating to financial transactions to be processed with a financial software system according to embodiments of the invention as described below in respect of the other figures. As shown first and second user groups 100A and 100B respectively interface to a telecommunications network 100, each of the first and second user groups 100A and 100B representing portable electronic devices (PEDs) and fixed electronic devices (FEDs) respectively which may according to embodiments of the invention be sources of transactions requiring processing through a financial software system according to an embodiment of the invention or processing one or more financial instruments thereby providing alternate data to be processed by a financial software system according to an embodiment of the invention. Within the representative telecommunication architecture a remote central exchange 180 communicates with the remainder of a telecommunication service provider's network via the telecommunications network 100 which may include for example long-haul OC-48/OC-192 backbone elements, an OC-48 wide area network (WAN), a Passive Optical Network, and a Wireless Link. The central exchange 180 is connected via the telecommunications network 100 to local, regional, and international exchanges (not shown for clarity) and therein through telecommunications network 100 to first and second wireless access points (AP) 195A and 195B respectively which provide Wi-Fi cells for first and second user groups 100A and 100B respectively.

Also connected to the telecommunications network 100 are first and second Wi-Fi nodes 110A and 110B, the latter of which being coupled to telecommunications network 100 via router 105. Second Wi-Fi node 110B is associated with first commercial building 160A and environment 160 within which are first and second user groups 100A and 100B. First commercial building 160A for example may be a retailer's retail location, a shopping centre, a restaurant, a market or another location wherein a user and provider of wares/services may engage as two parties of a transaction committing a discrete or recurring financial commitment from the user to the provider of a ware, wares, service, or services. Second user group 100B may also be connected to the telecommunications network 100 via a wired interface examples of which include, but are not limited to, DSL, Dial-Up, DOCSIS, Ethernet, G.hn, ISDN, MoCA, PON, and Power line communication (PLC) which may or may not be routed through a router such as router 105.

Within the cell associated with first Wi-Fi node 110A the first group of users 100A may employ a variety of PEDs including for example, laptop computer 155, portable gaming console 135, tablet computer 140, smartphone 150, cellular telephone 145 as well as portable multimedia player 130. Within the cell associated with second Wi-Fi node 110B are the second group of users 100B which may employ a variety of FEDs including for example, gaming console 125, personal computer 115 and wireless/Internet enabled television 120 as well as cable modem 105.

Also connected to the telecommunications network 100 are first and second APs 195A and 195B respectively which provide, for example, cellular GSM (Global System for Mobile Communications) telephony services as well as 3G and 4G evolved services with enhanced data transport support. Second AP 195B provides coverage in the exemplary embodiment to first and second user groups 100A and 100B. Alternatively the first and second user groups 100A and 100B may be geographically disparate and access the telecommunications network 100 through multiple APs, not shown for clarity, distributed geographically by the network operator or operators. First AP 195A as show provides coverage to first user group 100A and environment 160, which comprises second user group 100B as well as first user group 100A. Accordingly, the first and second user groups 100A and 100B may according to their particular communications interfaces communicate to the telecommunications network 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-2000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly portable electronic devices within first user group 100A may form associations either through standards such as IEEE 802.15 and Bluetooth as well in an ad-hoc manner.

Also connected to the telecommunications network 100 are financial clearing house 165, second commercial environment 160B, service provider 170A, utility provider 170B, and first and second financial providers 175A and 175B respectively. Accordingly, users within first and second commercial environments 160A and 160B may trigger requests for periodic recurring financial transactions from a financial institution, such as first or second financial providers 175A and 175B respectively, as a result of an activity such as a purchase of an item and/or service. These periodic recurring financial transactions may be undertaken directly with the respective one of the first and second financial providers 175A and 175B respectively or brokered through financial clearing house 165. The user may also trigger aperiodic recurring financial transactions as the result of activities with a service provider 170A and periodic recurring financial transactions such as those triggered with utility provider 170B.

As depicted in FIG. 1 the first commercial environment 160A is depicted as being linked to telecommunications network 100 with a wired interface via router 105. In many instances each of the financial clearing house 165, second commercial environment 160B, service provider 170A, utility provider 170B, and first and second financial providers 175A and 175B respectively will be similarly interfaced to the telecommunications network 100 via wired interfaces. However, in other instances a user may be undertaking a purchase from a provider of a service and/or wares directly an electronic device such as a PED wherein they form part of first user group 100A with wireless interfaces or a FED wherein they form part of second user group 100B with wired interfaces. In other instances the user may, for example, trigger a periodic recurring financial transaction using their PED with a provider using a PED or with a credit/debit card with a point-of-sale terminal interfaced directly to a PED such as those provided by Square (www.squareup.com).

In many instances periodic and aperiodic periodic recurring transactions arise based upon an entity, such as the service provider 170A and/or utility provider 170B executing a periodic or aperiodic recurring billing process to a user which then results in a financial transaction being made against a financial instrument of the user. Such a financial instrument may include, but not be limited to, a bank account, a credit account, and a debit account. In other instances the transactions arise from activities of the user including, but not limited to, making a purchase of a ware, making a purchase of a service, making a reservation relating to a ware, making a reservation relating to a service, making a donation, and sending a financial gift.

According to embodiments of the invention the processing of periodic and aperiodic financial transactions may be handled directly by a financial provider, directly by the retailer/service provider, or through an intermediate financial brokering service, such as provided for example by the Applicant rather than directly by the provider of the wares/services associated with the periodic and aperiodic financial transactions thereby offloading infrastructure requirements from the provider of the wares/services to the intermediate financial brokering service. Accordingly, intermediate financial brokering service operates first and second servers 190A and 190B which together with others not shown for clarity, may host according to embodiments of the inventions multiple services associated with a provider of the intermediate financial brokering service including, but not limited to, software operating system(s) and/or software application(s) associated with establishment, maintenance, and execution of periodic and aperiodic financial transactions relating to either a user or a provider of wares and/or services. First and second servers 190A and 190B respectively may also include additional elements including, but not limited to, product databases, inventory management databases, retail pricing databases, license databases, customer databases, websites, and software applications for download to or access by fixed and portable electronic devices. First and second primary content sources 190A and 190B may also host, for example, other services, including, but not limited to, Internet services such as a search engine, third party applications, other Internet based services, communications services, reporting services, and management services.

It would be evident that communications between many elements including, but not limited to first commercial environment 160A, second commercial environment 160B, service provider 170A, utility provider 170B, first and second financial providers 175A and 175B respectively, and first and second user groups 100A and 100B in communicating to/from the network 100 and other aspects of the network may employ one or more of the known transport level encryption methods within the prior art. For example this may be Transport Level Security (TLS) or Secure Sockets Level (SSL) encryption wrapped by GSM mobile stream encoding such as A5/3.

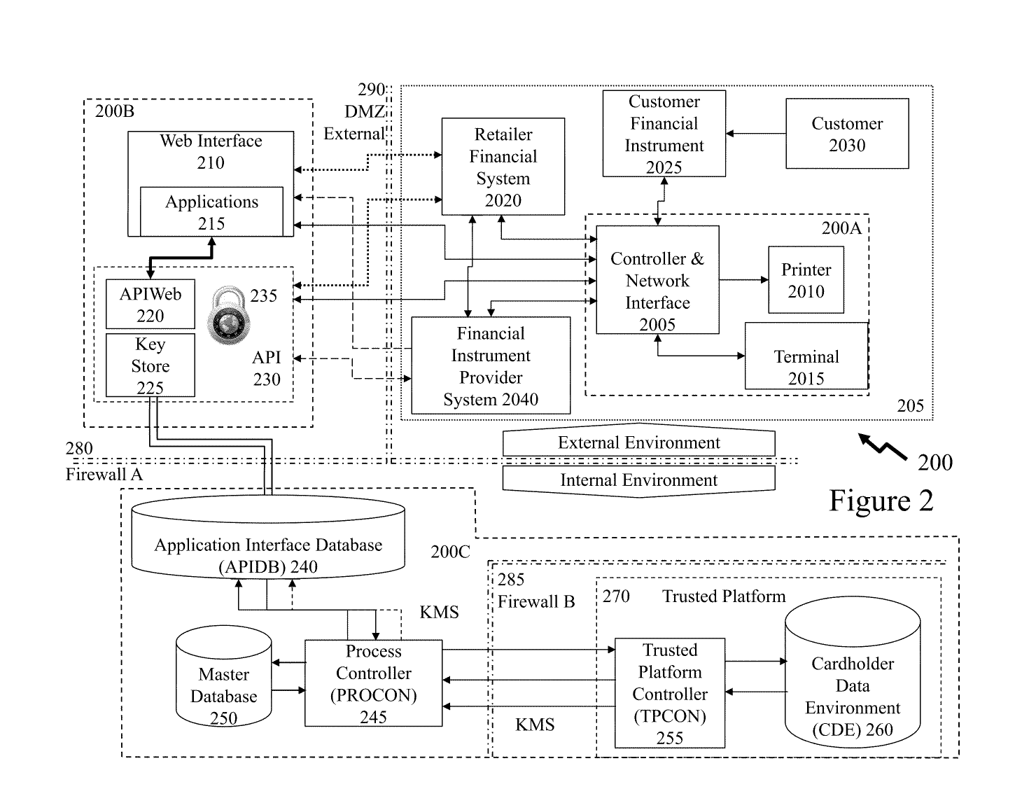

Now referring to FIG. 2 there is depicted schematic system architecture 200 for a system implementing financial transactions according to embodiments of the invention. As depicted external third parties, represented by External World 205, may engage the Application Interface 230 of the system architecture 200 indirectly via a web based user interface, represented by Web Interface 210, or for those clients with client interfaces directly via Web based Application Interface (APIWeb) 220. Users engaging via Web Interface 210 access one or more software applications, denoted by Applications 215, which then communicate to the APIWeb 220 within the API 230. Also within API 230 is a Key Store 225 as well as any digital security certificates, represented by Certificate 235.

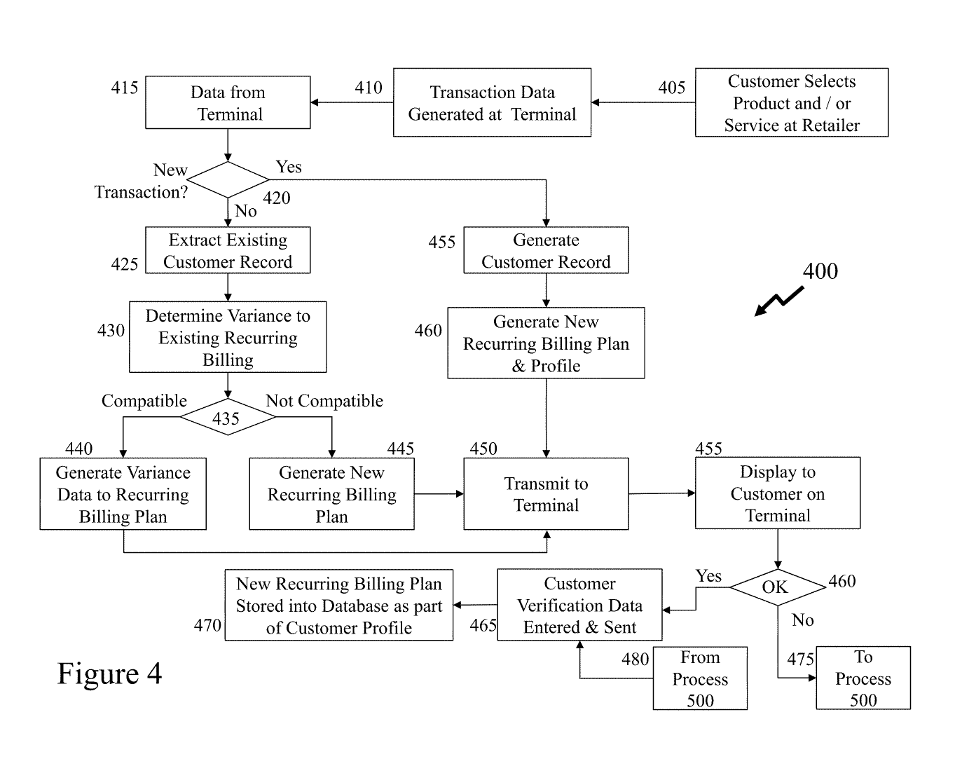

Within the External World 205 a Customer 2030 provides a Customer Financial Instrument 2025 to a Point of Sale (POS) 200A as part of a transaction. The POS 200A comprises a Terminal 2015, a Printer 2010, and POS Controller & Network Interface (POSCNI) 2005 such that the Customer 2030 may perform the transaction with the Terminal 2015 and received a printed receipt from the Printer 2010. The transaction details are communicated by the POSCNI 2005 to at least one of the Retailer Financial System 2020, the Financial Instrument Provider System 2040, the Web Interface 210, and API 230. As depicted Web Interface 210 and API 230 being partitioned behind a demarcation zone (DMZ) External 290 from the External World 205 and form Recurring Billing Interface (RECBI) 200B. Optionally, each of the Retailer Financial System 2020 and the Financial Instrument Provider System 2040 are in communication with one or both of the Web Interface 210 and API 230 within the RECBI 200B as well as each other. Accordingly, as the Customer 2030 performs the transaction process at the Terminal 2015 to establish a periodic or aperiodic recurring billing process information relating to the transaction may be transmitted directly from the POS 200A to RECBI 200B and therein to Recurring Billing System (RECBIS) 200C or alternatively may be transmitted to RECBI 200B and then RECBIS 200C via one or other of the Financial System 2020 and the Financial Instrument Provider System 2040. As discussed below, for example in respect of FIG. 4, information transmitted to RECBI 200B and RECBIS 200C may include unique customer information, such as financial instrument identity data, client verification data, and billing request data in order to establish a new recurring billing process or establish a modification to an existing recurring billing process for example. For example, a user enters a cellular provider's retail outlet and wishes to upgrade their smartphone. Within the prior art such a simple customer requirement requires a lengthy process be undertaken by a retail salesperson whereas accordingly to embodiments of the invention the customer can perform this automatically at a self-checkout Terminal for example. In performing the transaction the POS 200A transmits information to the Retailer Financial System 2020 which then accesses the RECBIS 200C via RECBI 200B to establish whether any existing recurring billing processes exists for the customer wherein this is extracted, transmitted to the Retailer Financial System 2020 wherein it is processed and transmitted to the POS 200A wherein the customer, is presented with the recurring billing information wherein they indicate acceptance/rejection by their actions upon the POS 200A. For example, entry of customer verification data indicates acceptance wherein this fact is then processed back through the Retailer Financial System 2020, RECBI 200B and RECBIS 200C to the Trusted Platform 270 wherein it is stored for subsequent processing through the recurring billing operations of RECBIS 200C. Optionally, Financial Instrument Provider System 2040 may be provided details of the recurring billing process either in short form or detail as well as it being recorded by Retailer Financial System 2020 that the customer has this billing process associated with the wares/services of the retailer. Notification to the Financial Instrument Provider System 2040 may be necessary in order to avoid the recurring billing process triggering a fraud indication and halt of the financial instrument. This may arise, for example, where in an embodiment of the invention as described below recurring billing can be established with recurring frequencies of minutes, seconds, hours rather than the traditional monthly, annual cycles associated with recurring billing processes within the prior art.

In operation irrespective of whether the External World 205 communication is to the Web Interface 210 or API 230 it is directed through the API 230 which communicates to a remote database, Application Interface Database (APIDB) 240, which is behind a first firewall, Firewall A 280. The APIDB 240 acts as a request/response server to the API 230 via requests which are forwarded from the API Database 240 to one or more Process Controllers (PROCONs) 245 and responses received from the Process Controllers (PROCONs) 245. APIDB 240 and PROCONs 245 also communicate security key information forming part of an overall Key Management System (KMS) but via a separate channel to the requests and responses although the security information is transmitted to the API 230 over the same channel as the other information transmitted from the APIDB 240 to the API 230. A PROCON 245 communicates with Master Database 350 as well as with Trusted Platform Controller (TPCON) 255 which forms part of Trusted Platform 270. Requests to and from PROCON 245 to TPCON 255 are parsed by a second firewall, Firewall B 285. Additionally, the PROCON 245 and TPCON 255 may communicate via a separate channel information relating to the overall Key Management System (KMS). The TPCON 255 itself also communicates to Cardholder Data Environment (CDE) 260 within the Trusted Platform 270.

It would be evident that communications between elements including, but not limited to External World 205, Application Interface 230, Web Interface 210, and APIWeb 220, in communicating to/from each other may employ one or more of the known transport level encryption methods within the prior art. For example this may be Transport Level Security (TLS) or Secure Sockets Level (SSL) encryption wrapped by GSM mobile stream encoding such as A5/3. Additionally, as depicted between the External World 205 and the Application Interface 230, Web Interface 210, and APIWeb 220 is a firewall demarcation zone (DMZ), DMZ External 290. Accordingly it would be evident that DMZ External 290 represents a conventional firewall as may exist using solutions known within the prior art and that Firewall A 280 and Firewall B 285 represent additional firewalls according to embodiments of the invention and do not replace firewalls/DMZs that would otherwise exist.

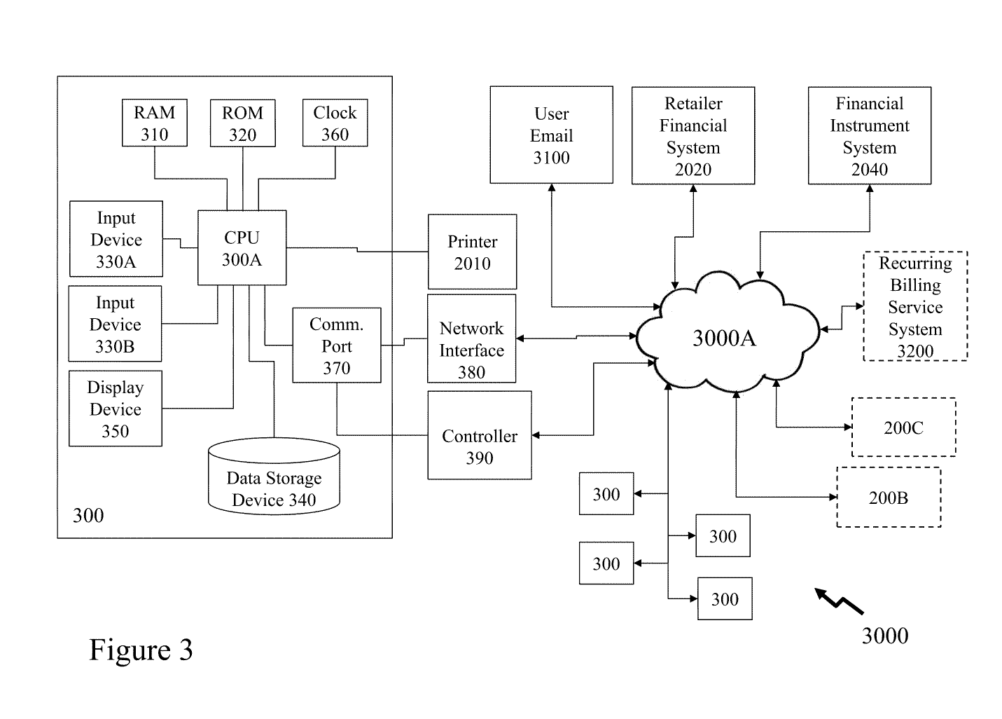

Now referring to FIG. 3 there is illustrated one embodiment of a Terminal 300 within a networked environment 3000 according to an embodiment of the invention. Terminal 300 being for example Terminal 2015 in FIG. 2. As shown in FIG. 3 the Terminal 300 includes central processing unit (CPU) 300A, random access memory (RAM) 310, read-only memory (ROM) 320, first and second Input Devices 330A and 330B respectively, Data Storage Device 340, Display Device 350, Clock 360, and at least one Communication Port 370. The Communication Port 370 is interfaced to POS Network Interface 380 and POS Controller 390 which together represent POSCNI 2005 for example in FIG. 2. Although Printer 2010 is illustrated in FIG. 3 as a separate element of Terminal 300, such as also illustrated in FIG. 2, the Printer 2010 may also be incorporated into Terminal 300 in alternative embodiment such that Terminal 300 basically functions as a conventional digital cash register equipped with the additional functionality described herein. Similarly, first and second Input Devices 330A and 330B respectively may individually or in combination be part of Terminal 300 or separate. For example, first Input Device 330A may be financial instrument interface, such as for example a magnetic card reader, a chip card reader, a Near Field Communication interface, an RF tag interface, an alphanumeric keyboard, a numeric keypad, a bar code scanner, a disk drive, a memory, a USB interface, a memory card interface, an electronic communication line, and a wireless transceiver.

Second Input Device 330B may be a credential entry or user entry device, such as for example a keypad, a keyboard, a touchscreen, a stylus interface. Accordingly, these may be integrated into the Terminal 300 or as known in the art be a separate interface unit, e.g. a wired or wireless POS device, interfacing to a cash register for example. However, in other embodiments of the invention the Terminal 300 may be a PED or FED to which a card reader or wireless POS card reader/keypad unit is attached such as for example a smartphone with a Square card reader or a tablet with a USB Swiper. Optionally, a Terminal 300 as considered within the scope of the embodiments of the invention may include, but not be limited to, an ATM, a PED, a FED, or other electronic device supporting user data entry and communications to a network. Accordingly, presentation of a financial instrument may include, for example, magnetic stripe swiping, chip reading, RF scanning, optical scanning, image capture and graphics image processing, and customer alphanumeric keypad entry.

As shown in FIG. 3, CPU 300A is directly coupled to each of the other elements of Terminal 300 with the exception of POS Network Interface 380 and POS Controller 390 which are coupled to it via Communication Port 370. CPU 300A executes program code (not shown) stored in one or more of RAM 210, ROM 220, and Data Storage Device 240 to carry out the functions and acts described in connection with Terminal 300. CPU 300A preferably comprises at least one digital data processor adequate to execute program modules consistent with the invention, such as POS sales processes, communications to remote servers and databases, presentation of information to user, and receipt/transmittal of verification information. Embodiments of the invention may be additional program modules supporting recurring billing processes rather than being directly integrated into the normal Terminal software. According, to the requirements of the Retailer, Financial Instrument Provider, Recurring Billing service provider etc. multiple program modules may be provided to run in conjunction with the normal Terminal software or in other embodiments of the invention halt normal Terminal operations and execute only recurring billing processes. Within other embodiments of the invention these additional program routines or secondarily executed software/operating system etc. may be stored within the POS Controller 390 and either communicated to the CPU 300A or alternatively the POS Controller 390 takes over control of the Terminal 300 and suspends operations of the CPU 300A or interrupts communications to/from it.

Printer 2010 comprises, for example, a conventional Terminal printer suitable for printing various paperwork, such as receipts, contracts, agreements etc. in accordance with instructions from CPU 300A. However, in other embodiments of the invention this information may be electronically transmitted to the user's email via Communications Port 370 to POS Network Interface 380 and therein User Email 3100 via Network 3000A. Alternatively, this information may be stored onto the user's financial instrument through the Input Device 330A employed to read information from it. For example, where first Input Device 330A is a USB interface the data may be transferred to a device connected to the USB interface or where it is a wireless transceiver it may be communicated for example to the user's smartphone. Display Device 350 comprises, for example, a video driver sending signals and a screen receiving these video signals wherein the Display Device 350 is capable of displaying text, graphics, multimedia content etc. under the control of CPU 300A. Display Device 350 is preferably large enough to display information relating to general sales, as well as subscription sales, to the cashier and/or customer. Optionally, two or more Display Devices 350 may be part of the Terminal to present information to the user and cashier rather than requiring a single display to be moved/rotated.

Communication Port 370 links CPU 300A with POS Network Interface 380 to allow CPU 300A to communicate with other Terminals 300, for example via Network 3000A, as well as User Email 3100, Retailer Financial System 2020, Financial Instrument System 2040, and RECBI 200B and RECBIS 200C. POS Controller 390 which is also coupled to Communications Port 370 in Terminal 300 as well as to User Email 3100, Retailer Financial System 2020, Financial Instrument System 2040, RECBI 200B, and RECBIS 200C. POS Controller 390 is also connected to Recurring Billing Service System 3200 which provides data, program modules etc. to the POS Controller 390 which are either executed by the POS Controller 390 and/or CPI 300A as described above in providing the required functions at the Terminal 300 for the recurring billing processes relating to the establishment, modification, etc. of these recurring transactions. Accordingly, variations in the process upon a Terminal 300 may be encoded and transferred from the Recurring Billing Service System 3200 to all Terminals 300 via the Network 3000A.

Referring to FIG. 4 there is depicted an exemplary process flow 400 relating to the establishment of a recurring billing process at a Terminal according to an embodiment of the invention. The process begins at step 405 wherein a customer selects product and/or service at a retailer and then proceeds to begin a purchase at a Terminal wherein in step 410 transaction data is generated at the Terminal. Where this relates to a recurring billing process then this data is then transmitted in step 415 to a recurring billing process, for example RECBIS 200C via RECBI 200B. At step 420 a determination is made as to whether the transaction data relates to a new transaction or to a modification of an existing recurring billing transaction. When the determination is negative the process proceeds to step 425 and extracts an existing customer record based upon information contained within the transaction data received from the Terminal. Such information may include, for example, correlating the financial instrument identity, e.g. credit card number, debit card number, to records already stored within the Master Database 250 or Cardholder Data Environment 260 for example.

Next in step 430 the variance in the recurring billing as a result of the transaction the customer wishes to make is calculated and then in step 435 it is determined whether the variance is compatible or incompatible with the existing recurring billing process. The rules in respect of determining compatibility may include, but not be limited to, considerations relating to maximum billing charge per billing event, adjustment in billing frequency, adjustment in billing period, and number of billing cycles. For a compatible variance the process proceeds to step 440 wherein data relating to the variance in the recurring billing plan is generated and then in step 450 transmitted to the Terminal. For an incompatible variance the process proceeds to step 445 wherein data relating to a new recurring billing plan is generated and then in step 450 transmitted to the Terminal. Where the determination is made in step 420 that this is a new transaction then the process proceeds to step 455 wherein a new customer record is generated and then in step 460 a new recurring billing plan is generated together with a customer profile before in step 450 the new recurring billing plan data is transmitted to the Terminal.

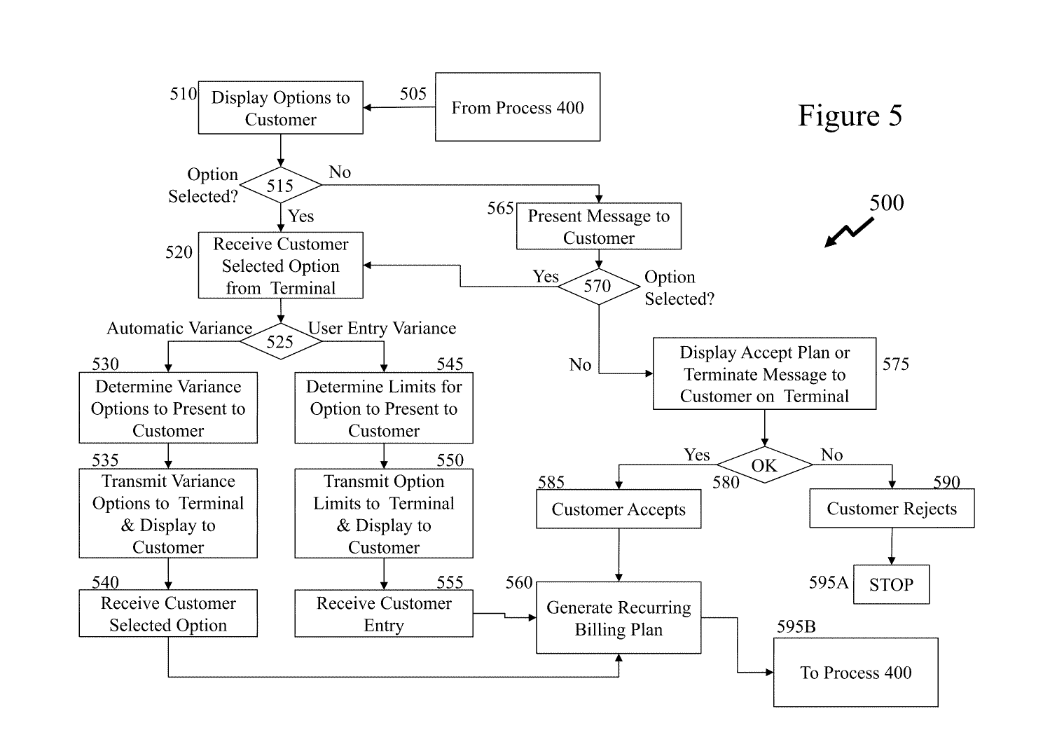

In step 455 the recurring billing plan data received in step 450 by the Terminal is displayed to the customer wherein an indication is provided in step 460 as to the customer's acceptance or rejection. For example, this may be via conventional prompts and key options as presented to a user on Terminal during a normal purchasing transaction. If the customer accepts then the process proceeds to step 465 wherein the customer enters verification data, e.g. a signature, a personal identification number, an item of biometric data, which when verified is then transmitted to the RECBIS 200C, for example, for storage in association with the new and/or modified recurring billing plan. Where the customer rejects the recurring billing plan presented the process proceeds to Process 5000 as described below in respect of FIG. 5.

Now referring to FIG. 5 there is depicted an exemplary process flow 500 relating to the establishment of a recurring billing process at a Terminal according to an embodiment of the invention. The process begins at step 505 which is equivalent to process step 475 in process flow 400 where the customer has rejected the recurring billing plan presented to them. Next in step 510 the customer is presented options in respect of the billing plan as defined by the retailer, for example automatically through Retailer Financial System 2020 based upon one or more aspects of the intended transaction such as price, product, interest rate, original term, etc. for example, or the financial instrument provider, for example automatically through Financial Instrument System 2040 based upon one or more aspects of the intended transaction such customer credit rating, customer history, customer financial ratio of debt to income, retailer, original term, etc. for example. Accordingly, in step 515 a determination is made as to whether the customer has selected an option presented to them and proceeds to step 520 upon a positive determination wherein the customer selection option is received. Next in step 525 a determination is made as to whether the customer selected option has automatic variance determination or user entry variance determination.

If the option selected has automatic variance determination the process proceeds to step 530 wherein variance options to present to the customer are determined, these are transmitted to the Terminal in step 535, and the process receives the customer selected option in step 540. For example, the customer in step 510 selected “Term” which was originally set to 36 months with a recurring billing value and is accordingly presented in step 535 options for 30, 36, 42, and 48 months each with a recurring billing value associated with it. Hence, the customer may have selected 48 months. Alternatively, the customer may have selected “Frequency” which was originally set to monthly and is presented with options for weekly, fortnightly, and bi-monthly each with an associated recurring billing value. In this instance, due to their employment situation they have selected weekly. From step 540 the process proceeds to step 560 wherein the recurring billing plan with user variations is generated and the process proceeds to step 595B and therein back to step 480 in process flow 400 for their acceptance and closure of the financial transaction process.

Alternatively, if the customer in step 520 has selected an option with user defined entry variance the process proceeds to step 545 wherein the acceptable limits for the option are presented to the customer, wherein the process transmits the options to the Terminal in step 550 and receives the customer entry in step 555 before proceeding to step 595B and therein back to step 480 in process flow 400 for their acceptance and closure of the financial transaction process. For example, the customer in step 510 selected “Day” and is presented with options 1 to 28 representing days 1 to 28 of the month for a monthly recurring billing allowing the user to establish the recurring billing in respect of their pay for example. Alternatively, the Financial Instrument Provider operating in conjunction with the RECBIS establishes that whilst the customer has presented a first financial instrument that they actually have a plurality of financial instruments and that one or other of these may be appropriate for establishing the recurring billing process against. Accordingly, the customer is presented in step 550 with these financial instruments and hence makes a selection. Optionally, the user is presented with a single selected alternate financial instrument based upon a determination made by their Financial Instrument Provider and given the option to accept or reject this in place of the financial instrument they initially present for the transaction.

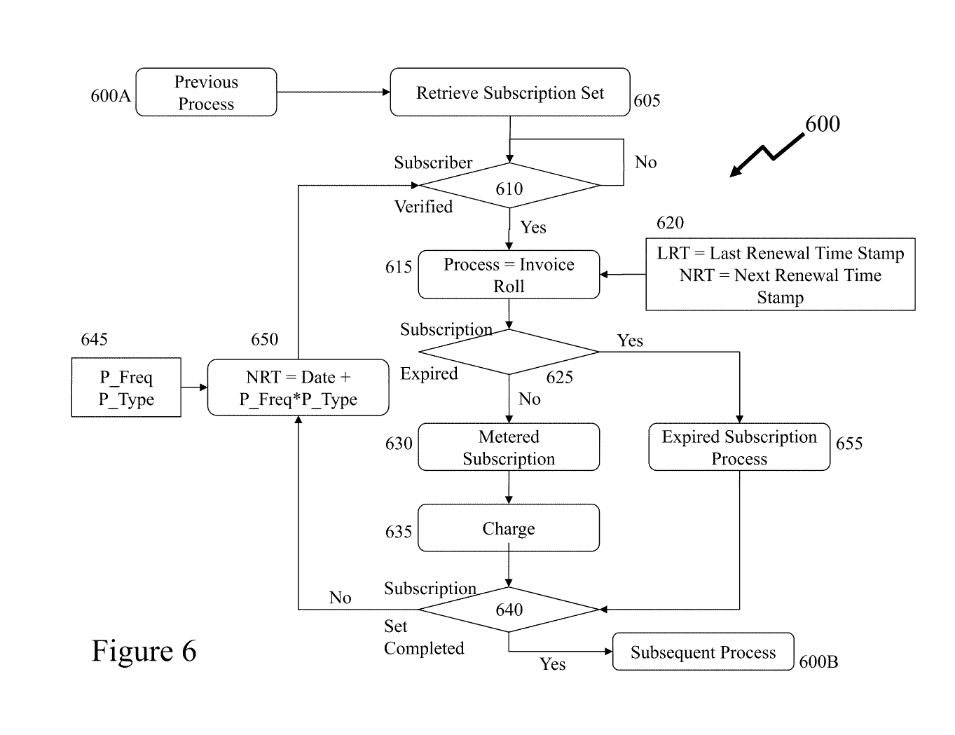

As described supra according to an embodiment of the invention a Recurring Billing System, such as RECBIS 200C in FIG. 2, executes and performs recurring billing. FIG. 6 depicts an exemplary process flow 600 for processing a batch of subscriptions, each subscription being recurring billing sequence, as part of an overall software application according to an embodiment of the invention. The process therefore starts at step 600A with a prior portion of the software application calling the batch subscription process. The process therefore in step 605 retrieves the set of subscriptions to be processed which may be a predetermined portion of an overall database of subscriptions before progressing forward to step 610 wherein a subscriber associated with the first subscription of the set of subscriptions is validated. If the validation fails the process loops to the next subscriber otherwise the process proceeds to step 615 wherein the data for this process, in this instance an invoice roll, is retrieved from the appropriate database, such as CDE 260 in FIG. 2. In this exemplary process flow 600 the data retrieved is Last Renewal Time Stamp (LRT) and Next Renewal Time Stamp (NRT) wherein the process proceeds to step 625 to determine whether the subscription for this subscriber has expired. If the determination is positive then the process proceeds to step 655 wherein an expired subscription process is executed and the process proceeds to step 640. Otherwise the process proceeds to step 630 wherein any metered subscription data is calculated for the subscriber, such as for example the subscriber has a monthly cellular subscription giving them a predetermined number of free minutes wherein excess minutes are charged at a predetermined rate, these excess minutes therefore forming part of the metered subscription calculation along with other elements relating to the subscriber account and the client account to whom the subscriber has a subscription. Accordingly having calculated the metered subscription data for the subscriber the process proceeds to step 635 wherein the metered subscription and subscription are charged to the financial instrument of the subscriber they provided to the client when registering their subscription.

From step 635 the process proceeds to step 640 wherein it is determined whether the subscription set being processed has been completed. If yes then the process proceeds to step 600B and subsequent processes of the software application are executed. If not then the process proceeds to step 650 wherein the process calculates the new NRT, NRT=Date+P_Freq×P_Type, wherein P_Freq and P_Type are variables relating to the subscribers subscription extracted by the process from a database, such as CDE 260 in FIG. 2, by the process in step 645. From process step 645 the process returns to step 610. According to an embodiment of the invention P_Type=0, 1, 2, 3, 4, 5, 6, and 7 for subscription frequencies defined in terms of:

P_Type=0—frequency=second;

P_Type=1—frequency=minute;

P_Type=2—frequency=hour;

P_Type=3—frequency=day;

P_Type=4—frequency=week;

P_Type=5—frequency=month;

P_Type=6—frequency=quarter; and

P_Type=7—frequency=year, respectively.

According to other embodiments of the invention P_Type may define subscription frequencies established in dependence upon one or more factors including, but not limited to, the ware(s) and/or service provider(s), user preferences, the ware(s), the service(s) and the provider of the Internal Environment as described in respect of FIGS. 2A and 3A respectively. Other P_Type values may be established for simplicity of management with respect to the External World but may be processed internally as another P_Type value. For example, P_Type=29 relates to a frequency of lunar cycles wherein a single cycle of P_Type=29 is internally processed as {P_Freq,P_Type}={29,3}, i.e. 29 days. Whilst P_Type may be an integer in some embodiments of the invention in others it may be free-form, e.g. P_Type=1 defines minutes and P_Type=LUN defines lunar cycle.

According to an embodiment of the invention P_Freq=1, 2, 3, 4, . . . is an integer number defining the number of subscription periods for recurrence of the billing process. However, it would be evident that according to other embodiments of the invention that P_Freq may be any numeric value, e.g. P_Freq=0.5, such that for example an External World system that has legacy systems establishing billing cycles as monthly, and hence automatically as P_Type=5, may provide clients with alternate billing cycles such as weekly or bi-monthly by setting P_Freq=0.25 and P_Freq=0.5 respectively. In contrast, another External World system may support weekly billing cycles and hence {P_Freq,P_Type}={4,1} and {P_Freq,P_Type}={4,2} respectively rather than {P_Freq,P_Type}={5,0.25} and {P_Freq,P_Type}={5,0.5} respectively. In other embodiments of the invention P_Freq may also be alphanumeric to support a wider range of options such that now NRT=Date+FN{P_Freq,P_Type}.

Accordingly, it would be evident that a wide variety of subscription duration types may be handled by an exemplary billing process such as described above in respect of FIG. 4 and process flow 600 with those ranging from per minute plans, such as wireless telecommunication services, to annual or biennial plans for example such as software licenses, magazine subscriptions, etc. Further, other time intervals may be employed including, but not limited to, seconds, bi-monthly, bi-annual, biennial, and triennial for example. Optionally, a financial transaction may be established with P_Freq=0 and P_Type=0 thereby resulting in the software application processing the transaction immediately or automatically upon first instance such that a financial transaction of this form may be applied to a single event, e.g. a purchase. It would also be evident that non-traditional subscriptions may be established according to embodiments of the invention such as every 20 days, 2 months, 5 minutes, 4 months, 5 days, 18 months, and 3 years for example.

Optionally, according to another embodiment of the invention a subscription may have multiple P_Freq, P_Type and financial values associated with it such that for example a subscriber may be charged an annual fee and a monthly fee for the same ware and/or service. Alternatively the multiple P_Freq and P_Type may allow billing to be provided as of the current date of executing the billing rather than based upon predetermined periods of time. Accordingly, a billing process run 6 weeks for a subscriber after their previous billing cycle may be charged for 6 weeks even though their contract with the provider is based upon a monthly fee. Similarly, a customer may be charged for a service on a monthly basis and then if they maintain the subscription for a year the process executes the annual charge which based upon their “credited” monthly subscriptions may be negative such that the subscriber receives a discount for maintaining their subscription for the year.

It would also be evident that a user's subscription may be adjusted with ease according to embodiments of an invention. For example, changing a user from a monthly subscription to an annual subscription is simply achieved either by adjusting P_Freq from 12 to 1 and adjusting P_Type from 5 to 7 with an appropriate adjustment in the Date to reflect the change in the user's subscription.

Optionally, in process step 635 wherein charging is determined for the subscription charges may be based upon flat rate cost structures or variable pricing structures such as for example tiered volume pricing discounts. Process flow 600 as presented above relates to a billing cycle for subscribers of a client who exploits the software system and software application as described above in respect of FIG. 2. Such an exemplary billing cycle may for example be triggered directly by a PROCON, such as PROCON 245 in FIG. 2. Optionally, the process flow 600 may include an additional process step wherein a batch of subscriber accounts are identified and scanned to determine accounts for processing. Such additional subscriber account filtering to that identified within the process flow 600 may for example relate to a particular client of the software system and software application or a predetermined subset of subscribers of the client, such as for example those within a predetermined geographic region or having predetermined characteristics of their accounts.

It would be evident that based upon the characteristics of the systems according to embodiments of the invention such as the exemplary billing process described above in respect of FIG. 6 and process flow 600 in conjunction with one or more PROCONs, e.g. PROCON 245 in FIG. 2, operating in conjunction with one or more PROCON Client Management Systems, not shown for clarity, that subscriber accounts may be processed continuously and in fact a subscriber account may be processed multiple times without a transaction being triggered to the subscriber account as the time of execution, CurrentTime, is such that CurrentTime<NRT<Date+FN{P_Freq,P_Type}.

It would also be evident, that the Master Database 250, or a plurality of Master Databases, may be partitioned based upon the initial P_Type and/or P_Freq or combination thereof. Similarly, PROCONS may be allocated based upon determinations made by a PROCON Client Management Systems, not shown for clarity, in dependence upon data extracted from Master Database 250, or plurality of Master Databases. Accordingly, with multiple PROCONS a subset of PROCONs may be allocated to performing subscriber account processing for P_Type={(0),(0,60)}, for example, associated with subscriber accounts with per second billing and billing frequencies of less than 60 whilst another subset of PROCONs may be processing P_Type={(1),(0,N)}, for example, associated with subscriber accounts with per second billing and billing frequencies of any frequency.

It would be evident that according to embodiments of the invention recurring billing processes may be established with fixed financial value per billing cycle or variable financial value per billing cycle such as for example a consumption based financial value. In addition, a recurring billing process may be established by {P_Freq,P_Type,N_Times} where now N_Times represents the number of times that the recurring billing is to be performed such that for example {P_Freq=1,P_Type=3,N_Times=365} means a charge will be applied daily for 365 days. {P_Freq=1,P_Type=4,N_Times=1} in contrast implies a single charge will be made in 1 week.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method comprising:
automatically establishing at a terminal a recurring billing process.

2. The method according to claim 1, wherein
the recurring billing process is characterised by a per installment charge, a charge frequency type, and a charge frequency count, wherein each installment is determined by the charge frequency type and the charge frequency count.

3. The method according to claim 1, wherein
the recurring billing process is automatically established based upon receipt at the terminal of first data relating to at least one of a product and a service and second data relating to a financial instrument.

4. The method according to claim 1, wherein
the recurring billing process is one of a plurality of recurring billing sequences established in dependence upon a single transaction at the terminal by a user.

5. The method according to claim 4, wherein
the recurring billing process relates to at least one of the purchase of a product by the user and the purchase of a service relating to a product purchased in the same transaction at the terminal.

6. A method comprising:
receiving at a terminal data relating to at least one of a product and a service;
receiving at the terminal data relating to a financial instrument associated with a user;
establishing in relation to the at least one of a product and a service a recurring billing process.

7. The method according to claim 6, wherein
the recurring billing process is established in respect of another financial instrument associated with the user.

8. The method according to claim 6, wherein
establishing the recurring billing process is establishing a variation to an existing recurring billing process.

9. The method according to claim 6, wherein
the recurring billing process is one of a plurality of recurring billing sequences established in dependence upon a single transaction at the terminal by a user.

10. The method according to claim 9, wherein
the plurality of recurring billing processes relate to the purchase of at least one of a product and a service by the user and the purchase of at least one service relating to the at least one of a product and a service purchased in the same transaction at the terminal.

11. The method according to claim 6, wherein
the recurring billing process only has one recurrence.

12. A method comprising:
establishing at a point of sale terminal data relating to a transaction to be performed by a user;
generating a recurring billing plan for the user in dependence upon at least the transaction established at the point of sale terminal;
presenting the recurring billing plan for the user upon the point of sale terminal establishing the point of sale terminal data; and
receiving from the user an indication relating to the recurring billing plan; wherein
upon a positive determination obtaining user verification data relating to the recurring billing plan and storing the new billing plan together with the user verification data; and
upon a negative determination establishing and presenting a variance of the recurring billing plan to the user.

13. The method according to claim 12, wherein
establishing a variance to the recurring billing plan comprises receiving from the user an indication of at least one of an automatic variance process and a user variance process; wherein
upon receipt of an indication of selection of the automatic variance process automatically establishing variance options relating to the recurring billing plan to the user; and
upon receipt of an indication of selection of the user variance process presenting to the user limits for at least one aspect of the recurring billing plan.

14. The method according to claim 12, further comprising
generating the recurring billing plan in dependence upon user entry data, the user entry data representing either selection of an option presented to the user within the automatic variance process or entry of a value in respect of a recurring billing plan characteristic within the user variance process.
